(19) United States
(12) Patent Application Publication
(10) Pub. No.: US 2004/0065728 A1
(43) Pub. Date: Apr. 8, 2004

(54) Integrated circuit card or smart card incorporating a security software card, and communication device co-operating with same

(76) Inventor: Didier Tournier, Marseille (FR)

Correspondence Address: BURNS DOANE SWECKER & MATHIS L L P, POST OFFICE BOX 1404, ALEXANDRIA, VA, 22313-1404, US

(21) Appl. No.: 10/470,192

(22) PCT Filed: Jan. 25, 2002
(86) PCT No.: PCT/FR02/00306

(30) Foreign Application Priority Data
Jan. 26, 2001 (FR) 01/01100

(51) Int. Cl. G06F 17/00

(52) U.S. Cl. 235/375

(57) ABSTRACT

The invention concerns an integrated circuit card (1) comprising a connection and communication interface (3′) designed to set up a communication with a host unit (2) in the form of a communication device and cryptographic software means (4′) for cryptographic calculations. Said card (1) is characterised in that the integrated circuit(s) (1′) further comprise(s) a security or security-providing software layer (4) designed to co-operate with said cryptographic software means (4′) to produce a set of security operations on the received data and to transmit via the connection and communication interface (3′) of said card (1).

The present invention relates to the field of transmissions by secure data communications means.

The invention relates in particular to services provided by communications based on the Internet protocol (“WWW” or “World-Wide Web”) and more particularly to an integrated circuit card enabling such transmissions to be made secure, to a communications set suitable for co-operating with such a card, to a set formed by associating the above-mentioned communications set with the above-mentioned card, and to a communications system including at least one such set.

In the present application, the term “integrated circuit card or smart card” applies to any medium in particular in the form of a plane plate of thermoplastics material, and enclosing at least one integrated circuit of the microprocessor type associated with a memory and with surface-mounted contact terminals. Such cards are of size adapted to the card-receiving slot in the host unit or in the connection module associated with said host unit and designed to receive such a card temporarily. Each of such cards is generally allocated personally and uniquely to an individual holder or user, and each card is associated with a confidential code known only to the user.

Typical but non-limiting examples of such cards are payment cards or credit cards.

It is already known that smart cards can be used as removable accessory components for authenticating or securing data transmitted or received by a host unit such as a computer, a cellphone, an electronic personal assistant, or a data processing and communications unit or the like.

Such a card either acts in a purely slave capacity as a session key provider, or in a more active capacity as a slave unit under the control of software means installed in the host unit and implemented thereby to provide to the user the services required by said user. In the latter case, the card performs a certain number of cryptographic computing procedures (verifying certificates, computing a session key, generating a signature, hashing, encoding, decoding, etc.) on request and as a function of requirements, e.g. from a browser, an explorer, a piece of electronic mail (e-mail) software, or a software entity of a communications or security layer. The above-mentioned items of resident software of the host unit cause the card to execute cryptographic computations that they need for the security layer installed in the host unit, so that said host unit can perform the set of security operations that are required.

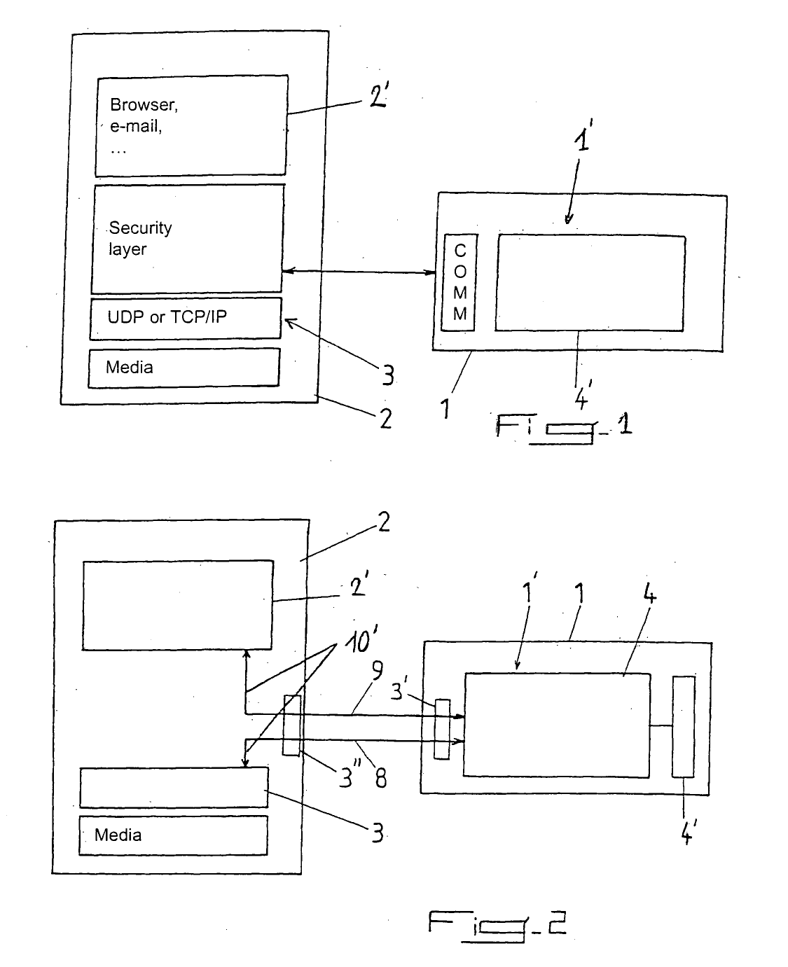

A general example of architecture for such a host/card association is shown diagrammatically in FIG. 1 (resident software 2′).

In the present application, the term “set of security operations” is used to mean the set of operations necessary for interchanging secure data with a “secure” remote unit. In particular, they comprise the set of algorithm functions that are currently found in the security layer of a communications protocol of the Internet type.

For example, the security or secure layer may be of the Secure Sockets Layer (SSL) type, of the Transport Layer Security (TLS) type, or indeed of the Wireless Transport Layer Security (WTLS) type.

The transmission protocols implemented in the communications interface 3 may, for example, be of the type known as the User Datagram Protocol (UDP) or as the Transmission Control Protocol (TCP), both of which are associated with Internet Protocol (IP) layers.

However, a major risk results from such use due to the session key being exported to the host unit (e.g. for encrypting), the risk being that said session key might be pirated by software of the type known as a “Trojan Horse” and that erroneous information might be generated.

In addition, because the security layer is installed in the host unit, any upgrading of it, to take account of the necessary upgrading in security techniques, is directly associated with a more general modification of the installed software or even with a change in host unit, in particular as regards consumer products.

The obsolete security layer installed in the host unit can lag considerably behind fast-changing piracy techniques, making the host unit extremely vulnerable during communications with the outside.

Finally, it is not generally possible at the host unit to customize and to adapt security measures as a function of the user.

A particular object of the present invention is to overcome at least some of the limitations and to mitigate some of the above-mentioned drawbacks.

To this end, the present invention principally provides an integrated circuit card including a connection and communications interface serving to set up a communication with a host unit in the form of a communications set and cryptographic software means for performing cryptographic computations, said integrated circuit card being characterized in that the integrated circuit or each of the integrated circuits further includes a security or secure software layer suitable for co-operating with said cryptographic software means to perform a set of security operations on the data received and to be transmitted via the connection and communications interface of said card.

The invention will be better understood on reading the following description which relates to a preferred embodiment, given by way of non-limiting example, and explained with reference to the accompanying diagrammatic drawings, in which:

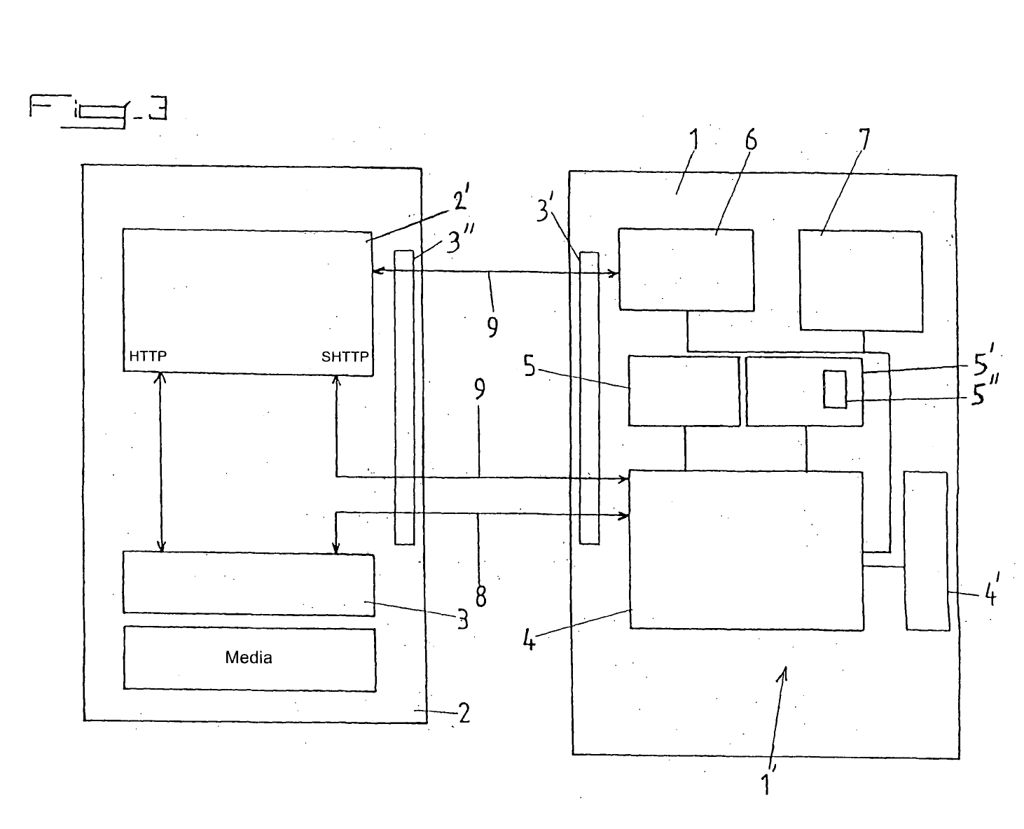

FIG. 2 is a block diagram of a possible architecture for a host unit, and for the card that can be associated therewith in a first variant embodiment of the invention;

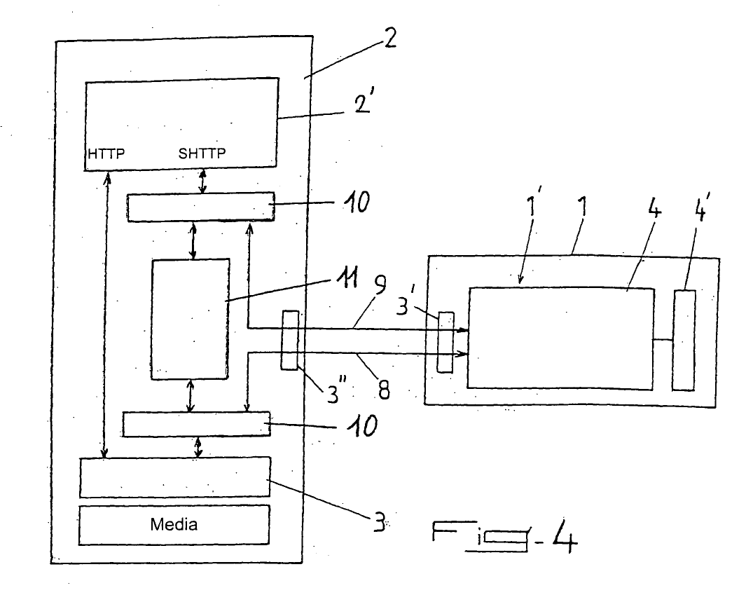

FIG. 3 is a block diagram similar to the FIG. 2 block diagram, incorporating a second embodiment of the card of the invention;

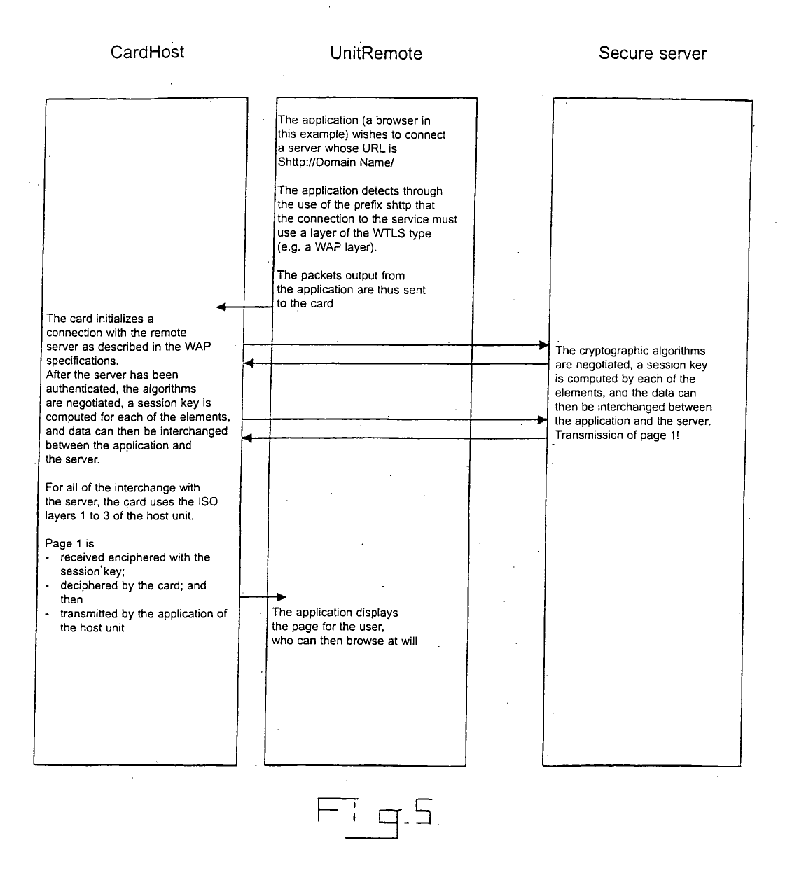

FIG. 4 is a variant embodiment of the architecture of a host unit that is part of a set similar to those shown in FIGS. 1 and 2; and

FIG. 5 is a flow chart showing an example of a communications set-up procedure based on the Wireless Application Protocol (WAP).

The present invention firstly relates to a card 1 having one or more integrated circuits 1′ and including a communications interface 3′ serving to set up a communication with a host unit 2 in the form of a communications set, and cryptographic software means 4′ for performing cryptographic computations.

This card is characterized in that the integrated circuit 1′ or each integrated circuit 1′ further includes a security or secure software layer 4 suitable for co-operating with said cryptographic software means 4′ to perform a set of security operations on the data received and to be transmitted via the connection and communication interface 3′ of said card 1.

Thus, the card of the invention offers the advantage of avoiding exporting the session key to the outside since said card itself includes the security software layer that is generally found in the host unit. As a result, communications are made more secure.

The card 1 advantageously includes a memory for storing the session key (or enciphering/deciphering key) and to which read access is authorized only for said security layer 4 of the card 1 so as to avoid access by means external to the card.

According to a first characteristic of the invention, the security software layer 4 has a function or a group of functions making algorithm and key negotiation possible, and an enciphering and deciphering function, and optionally a certificate authentication function.

Advantageously, in co-operation with said cryptographic software means 4′, said security software layer 4 is capable of performing a set of security operations making it possible to provide communications security of the “Internet” type.

In addition, said layer 4 is preferably chosen from the group formed by layers of the following types: SSL, TLS, WTLS or the like.

When solicited, said security software layer 4 is capable of processing all of, or optionally at least a portion of, the streams of data input and output via at least one communications interface 3 in said host unit 2 for connecting said unit to a communications network, by performing the required security operations on said data.

The card 1 can thus take account of the stream of data at the output of the customer software 2′ residing in the host unit 2 so as to subject it to the security operations and so as then to transmit it in secure form to the software layers which, in association with the interface 3, perform transport for the same host unit 2.

Symmetrically, the card 1 can also take account of the stream of data at the outputs of the transport software layers of the host unit 2 (in association with the interface 3) so as to subject it to the security operations, and so as then to transmit it, in secure form, to the resident customer software 2′ in question.

To avoid any excessive slowing down in transmitting the information, it is necessary to check that the transfer protocols and the hardware processing means present on the card 1 have an execution speed that is adapted to the maximum stream that can be interchanged between the host unit 2 and the card 1.

Based on a fast protocol of the Ethernet or General Packet Radio Service (GPRS) type on a radio medium of the Universal Mobile Telecommunications System (UMTS) type, data rates can reach several megabits per second, which implies that the internal architecture of the card must be designed to minimize slowing down of the streams of data (cryptographic solutions of the cabled Data Encryption Standard (DES) type, of the 16 kilobyte or 32 kilobyte Random Access Memory (RAM) type, of the Central Processing Unit (CPU) cache type, and of the 32 bit CPU type may be considered).

The card 1 therefore constitutes a security buffer that is removable from the host unit 2, and whose features may be customized as a function of the holder of the card (possibility of creating different security levels with the same host unit 2) and whose disconnection from the host unit 2 may, in a variant embodiment of the invention (see FIG. 2) lead to total hardware and software isolation between the communications interface 3 and the resident software 2′.

During certain transactions between a server or a remote host unit and the host unit 2 connected to the card 1, said server can transmit a determined form that the user must fill in and validate with an electronic signature in order to confirm the transaction.

A known type of piracy consists in modifying the form at the time of the signing step. Thus, the user does not sign the form that the user is viewing or that is displayed, but rather a false form substituted for the proper form, and representing, for example, a payment to another name, to another bank and/or of another amount. Such an attack is generally performed with piracy software of the “Trojan Horse” type.

In order to mitigate this risk, in a variant embodiment shown in FIG. 3 of the accompanying drawings, the invention makes provision for said card 1, or at least the integrated circuits that it carries, to include software means 5 for verifying forms or payment deeds or for validating transactions, which means are suitable for storing the form or deed received from the server or from the remote host unit.

At the time of the signing step, the software means 5 verify that no modification has taken place, and that, by signing, the customer does indeed validate what has been submitted to them visually for signing.

This verification operation may be performed by extracting static elements from said deed or form, by performing checking computation on said elements, and by verifying said computation when the resident software 2′ sends back said form or deed to said remote server.

For other transactions, the user can receive a page of text or a document of that type recapitulating the transaction that is in the process of being settled. In which case, when the user validates said transaction, a script or subprogram is executed for signing the document recapitulating the transaction.

It is then possible for a second document to be transmitted for signing (during the course of the signing step in the card) leading to a false transaction being signed and therefore validated. Such an attack is generally performed with software of the “Trojan Horse” type.

To avoid this risk, the invention makes provision for the card 1 to include software means 6 for automatically generating encrypted or enciphered signing.

The automatic signing operation (valid for data to be signed coming from the authenticated server with which a secure/enciphered session is in progress) takes place, for example, as follows.

The server sends to the customer (smart card and its host unit) a document that is to be signed by said customer. A software component scans the received document to detect whether it needs to be signed (a particular tag may, for example, make such detection possible). The software component can then pre-sign the document and present it to the user for confirmation. The signed document can then be returned to the server. It should be noted that, at no time, has the host unit been required to generate the signature.

Thus, when the document is transferred to the card 1, the signing software detects the document as coming from an authenticated remote server, and no other document can be signed during this connection, even on command from the host unit.

If “Trojan Horse” type software sends a request for a signing operation, said request is rejected by the security layer 4 of the card 1 and a warning message is sent to the user.

This mechanism may be extended to operations other than transactions with the remote server, e.g. to e-mails sent by the host unit 2, when the customer resident software 2′ is reliable.

Software means 7 may also be provided that are adapted for automatically verifying the signed documents, in particular the signatures on signed documents coming from the network (this applies more to e-mails or to documents of the same type). In order to make this possible, it is necessary to insert the means enabling the software to determine that the incoming document is signed, to determine which public key should be used to verify the document (such means may be a Uniform Resource Locator (URL) hyperlink giving the network address), or to retrieve said public key itself.

Finally, the card 1 may additionally include software means 5′ for automatically filling in forms or corresponding documents sent by a server or by a remote host unit in the context of a transaction in progress with said host unit.

Currently, the required data and information (e.g.: credit card number, date of expiry, address, etc.) must be entered manually by the user, and such data and information can easily be forgotten or put on an additional medium that might be mislaid, lost, or stolen.

By using the filling-in software means 5′ resident on the card 1, such information and data is pre-stored in a suitable register 5″, is automatically read, and serves to fill in the recognized fields of the document authenticated as coming from a secure server or from a secure host unit.

The user merely has to fill in the document with information not present in the register or in the data bank 5″ and then validate the document in which all of the fields have been filled in.

As shown in FIG. 4 and more diagrammatically in FIG. 3 of the accompanying drawings, the present invention also relates to a communications set 2 including a connection and communications interface 3 for connection to and communications with a communications network, a connection and communications interface 311 for connection to and communications with an integrated circuit card so as to constitute a host unit for said card, and a security software layer, said set being characterized in that it includes switching means 10 suitable for directing all or a fraction of a stream of data received or to be transmitted over its network interface 3 towards said card interface 3.

Preferably, said switching means 10 consist of software means and are suitable for directing said stream of data automatically towards said card interface 3″ when certain predetermined conditions are satisfied.

According to a characteristic of the invention, one of said predetermined conditions may lie in a more recent version of security software layer 4 being detected that is available in the card 1.

Thus, this function enables the user to enjoy a more recent and improved version of a security software layer merely by changing the card rather than the host set.

According to another characteristic of the invention, one or another of said predetermined conditions may lie in an address prefix being detected that indicates whether the communication is secure or to be made secure.

In another embodiment of the invention, shown in FIG. 2 of the accompanying drawings, the communications set 2 may not have its own security layer.

In which case, it includes a connection and communications interface 3 for connection to and communications with a communications network, and a connection and communications interface 3″ for connection to and communications with a card 1 of the invention that has one or more integrated circuits 1′ so as to constitute a host unit for said card.

This set is then characterized in that it includes forced transmission means 10′ that are, for example, cabled, and that direct the entire stream of data received or to be transmitted over its network interface 3 towards said card interface 3″.

In such a set, the card 1 constitutes an essential component that is necessary for it to operate. The absence of a card 1 of the invention totally isolates the resident software 2′ of the set 2 from the interface 3 and from the transport layers which are associated therewith.

In different possible variant embodiments of the invention, the communications set 2 in any of the two above-described embodiments, may, for example consist of a mobile radio-communications terminal, and in particular a cell phone, of a digital personal assistant, or of a communications module that is part of electronic or computer equipment, and in particular of a laptop computer.

The present invention also relates to a set for setting up secure communications via at least one communications network, said set being characterized in that it is constituted by associating a card 1 as described above with a communications set 2 as described above, forming a host unit for said card 1.

In such an embodiment, the card 1 incorporates a security software layer 4 suitable for performing the set of security operations required by the host unit 2, in particular for the data received and transmitted via said at least one communications interface 3, without the session key or the key negotiated between the card 1 and the remote unit in communication with the host unit 2 being transmitted to the host unit 2.

The card 1 implemented preferably has at least some of the additional characteristics mentioned above.

As shown in FIGS. 2, 3, and 4 in the accompanying drawings, the card 1 is connected to said host unit 2 via at least two distinct transmission channels, namely at least one network channel 8 and at least one application channel 9, transiting via the complementary interfaces 3′ and 3″ co-operating when the card 1 is connected to the communications set 2 forming the host unit.

FIG. 3 also shows that the host unit 2 may optionally have two parallel communication paths between the resident software 2′ and the communications protocols and the interface 3, namely a secure path passing through the card 1, and a non-secure path connecting the software 2′ directly to the interface 3, which paths may correspond to respective ones of two different transmission protocols, namely a protocol of the Hypertext Transfer Protocol (HTTP) type, and a protocol of the Secure Hypertext Transfer Protocol (SHTTP) type.

When the host unit 2 already includes a suitable connection interface for connection to a card, a modification of the software as described below makes it possible to use the security layer 4 of the card 1 in place of the security layer already existing in the host unit 2 (i.e. the existence of a security layer (e.g. of the SSL type) is not obligatory). Depending on the type of connection, the software modifications relate to the transport layer (Layer 3 of the International Standards Organization (ISO) model) so that the packets addressed to the card 1 are transmitted to it via its interface and via one of the application layers (optionally the Session layer or indeed the application directly).

The software of the host unit 2 must be modified such that, on detecting that such a card 1 has been inserted, said unit can propose to the user to use it. Such detection may be performed on a data zone that it is possible to retrieve as soon as the card is powered (response to reset or dedicated file).

An implementation example is for reserving a port number. Taking the example of the WAP, the various reserved port numbers all correspond to a type of connection. The transport layer then merely has to send the packets to the card whenever the card has been chosen to perform the security for setting up the connection and for the consecutive communication and whenever the port number indicates that said connection and said communication must implement such a layer.

The procedure for detecting the type of card (current card or card 1 of the invention with security layer service) when a card is inserted into the slot of a corresponding software interface in the host unit 2 or when said unit 2 is switched on, and for the consecutive operations, is described more precisely below.

When the card is inserted or when the host unit 2 is switched on (with initializations specific to said unit being executed), said host unit is firstly powered.

Two situations can then arise:

the card sends to the unit an authentication sequence; in which case, the unit 2 analyzes said sequence and verifies that the card in question does indeed provide a security layer for connections to secure servers;

the card does not react on being powered (at least from the point of the view of the host unit); in which case, said unit 2 seeks information describing the functions and specificities of the inserted card by means of a special command (read file or the like).

In both of the above-mentioned cases, if the card proposes the secure layer service, the host unit 2 can position a variable or set to 1 a similar indicator (flag), thereby enabling it to indicate to the layers or software in question that the communications with a secure server must be based on the security services of said card 1, i.e. direct towards said card the data and information coming from or going to the connected secure server.

This switching may be performed automatically (as explained above—preferred solution), or optionally on decision from the user subsequent to a man-machine dialogue.

A possible procedure for setting up a communication with a secure server and the beginning of the consecutive transmission are shown, by way of example, in the flow chart of FIG. 5 of the accompanying drawings.

Finally, the present invention additionally relates to a communications system for interchanging secure data, said system including at least one set formed by associating a card 1 and a communication set 2 as described above, connected via a communications network (wireless, wire, combined, or some other type) to another analogous set, or to a secure server, or to a secure unit.

Naturally, the invention is not limited to the embodiments described and shown in the accompanying drawings. Modifications remain possible, in particular as regards the construction of the various elements or by using equivalent substitute techniques, without going beyond the field of protection of the invention.

1. An integrated circuit card including a connection and communications interface serving to set up a communication with a host unit in the form of a communications set and cryptographic software means for performing cryptographic computations, said integrated circuit card being characterized in that the integrated circuit or each of the integrated circuits (1′) further includes a security or secure software layer (4) suitable for co-operating with said cryptographic software means (4′) to perform a set of security operations on the data received and to be transmitted via the connection and communications interface (3′) of said card (1).

2. A card according to claim 1, characterized in that said security software layer (4) includes a function or a group of functions making algorithm and key negotiation possible, and an enciphering and deciphering function.

3. A card according to claim 2, characterized in that the security software layer (4) further includes a certificate authentication function.

4. A card according to any one of claims 1 to 3, characterized in that, in co-operation with said cryptographic software means (4′), said security software layer (4) is capable of performing a set of security operations making it possible to provide communications security of the “Internet” type.

5. A card according to any one of claims 1 to 4, characterized in that said security software layer (4) is chosen from the group formed by layers of the following types: SSL, TLS, WTLS or the like.

6. A card according to any one of claims 1 to 5, characterized in that it includes a memory for storing the enciphering/deciphering key and to which read access is authorized only for said security layer (4).

7. A card according to any one of claims 1 to 6, characterized in that said security software layer (4) is capable of processing all of, or optionally at least a portion of, the streams of data input and output via at least one communications interface (3) in said host unit (2) for connecting said unit to a communications network, by performing the required security operations on said data.

8. A card according to any one of claims 1 to 7, characterized in that it further includes software means (5) for verifying forms or payment deeds or for validating transactions.

9. A card according to any one of claims 1 to 8, characterized in that it also includes software means (6) for automatically generating signing.

10. A card according to any one of claims 1 to 9, characterized in that it includes software means (5′) for automatically filling in forms or corresponding documents.

11. A card according to any one of claims 1 to 10, characterized in that it incorporates software means (7) for automatically verifying signed documents.

12. A communications set including a connection and communications interface for connection to and communications with a communications network, a connection and communications interface 3 for connection to and communications with an integrated circuit card according to any one of claims 1 to 11, so as to constitute a host unit for said card, and a security software layer, said communications set being characterized in that it includes switching means (10) suitable for directing all or a fraction of a stream of data received or to be transmitted over its network interface (3) towards said card interface (3″).

13. A set according to claim 12, characterized in that the switching means (10) consist of software means and are suitable for directing said stream of data automatically towards said card interface (3″) when certain predetermined conditions are satisfied.

14. A set according to claim 13, characterized in that one of said predetermined conditions lies in a more recent version of security software layer (4) being detected that is available in the card (1).

15. A set according to claim 13 or 14, characterized in that one of said predetermined conditions lies in an address prefix being detected that indicates whether the communication is secure or to be made secure.

16. A communications set including a connection and communications interface for connection to and communications with a communications network, and a connection and communications interface for connection to and communications with an integrated circuit card according to any one of claims 1 to 11, so as to constitute a host unit for said card, said communications set being characterized in that it includes forced transmission means (10′) that direct the entire stream of data received or to be transmitted over its network interface (3) towards said card interface (3″).

17. A communications set according to any one of claims 12 to 16, characterized in that it consists of a mobile radio-communications terminal, in particular a cell phone.

18. A communications set according to any one of claims 12 to 16, characterized in that it consists of a digital personal assistant.

19. A communications terminal according to any one of claims 12 to 16, characterized in that it consists of a communications module that is part of electronics or computer equipment, in particular of a laptop computer.

20. A set for setting up secure communications via at least one communications network, said set being characterized in that it is constituted by associating a card according to any one of claims 1 to 11 with a communications set according to any one of claims 12 to 19.

21. A communications system for interchanging secure data, said system including at least one set according to claim 20, connected via a communications network to another set according to claim 20, or to a secure server, or to a secure unit.
